(19) United States
(12) Patent Application Publication
(10) Pub. No.: US 2005/0233051 A1
(43) Pub. Date: Oct. 20, 2005

(54) Acid beverage composition utilizing a protein and a vegetable oil and process for making same

(75) Inventor: Cheng Shen, Kirkwood, MO (US)

Correspondence Address: SOLAE, LLC, P. O. BOX 88940, ST. LOUIS, MO, 63188, US

(73) Assignee: SOLAE, LLC

(21) Appl. No.: 10/825,501

(22) Filed: Apr. 15, 2004

(51) Int. Cl. C12C 1/00

(52) U.S. Cl. 426/590

(57) ABSTRACT

This invention is directed to an acid beverage composition, comprising; (A) a hydrated protein stabilizing agent; (B) a protein material;
(C) a triglyceride comprising a vegetable oil triglyceride, a genetically modified vegetable oil triglyceride or a synthetic triglyceride oil of the formula 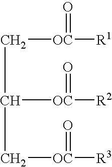
wherein R¹, R² and R³ are aliphatic groups and contain from about 7 up to about 23 carbon atoms; and (D) a flavoring material comprising a fruit juice, a vegetable juice, glucono delta lactone, phosphoric acid or the sodium salts or acids of citric acid, malic acid, tartaric acid, lactic acid and ascorbic acid; wherein the acid beverage composition has a pH of from 3.0 to 4.5. Also disclosed is a process for preparing an acid beverage composition.

### FIELD OF THE INVENTION

This invention relates to a process for preparing a protein based acid beverage which is smooth, tasteful, palatable and has good storage stability. In addition to a protein source, vegetable oils, stabilizing agents and a flavor material is also employed.

### BACKGROUND OF THE INVENTION

Juices and other acidic juice-like beverages are popular commercial products. Consumer demand for nutritional healthy beverages has led to the development of nutritional juice or juice-like beverages containing protein. The protein provides nutrition in addition to the nutrients provided by the components of the beverage. Recently it has been discovered that certain proteins have specific health benefits beyond providing nutrition. For example, soy protein has been recognized by the United States Food and Drug Administration as being effective to lower blood cholesterol concentrations in conjunction with a healthy diet. In response, there has been a growing consumer demand for acidic juice-like beverages containing proteins that provide such specific health benefits.

A hurdle to adding protein to acidic beverages, however, is the relative insolubility of proteins in an aqueous acidic environment. Most commonly used proteins, such as soy proteins and casein, have an isoelectric point at an acidic pH. Thus, the proteins are least soluble in an aqueous liquid at or near the pH of acidic beverages. For example, soy protein has an isoelectric point at pH 4.5 and casein has an isoelectric point at a pH of 4.7, while most common juices have a pH in the range of 3.7 to 4.0. As a result, protein tends to settle out as a sediment in an acidic protein-containing beverage-an undesirable quality in a beverage.

Protein stabilizing agents that stabilize proteins as a suspension in an aqueous acidic environment are used to overcome the problems presented by protein insolubility. Pectin is a commonly used protein stabilizing agent. Pectin, however, is an expensive food ingredient, and manufacturers of aqueous acidic beverages containing protein desire less expensive stabilizers, where the amount of required pectin is either reduced or removed in favor of less expensive stabilizing agents.

Soy milk is an alternative raw material that could be used in juice drinks, however, the low protein content of soy milk coupled with its beany flavor, limit the application of soy milk in juice drinks.

The advantage of this invention is that a soy protein is employed for acid beverages along with a vegetable oil. The soy protein and vegetable oil provide a stable emulsion over the shelf life of an acid beverage composition and is accomplished by giving body to the acid beverage composition. An emulsion based acid beverage composition also has stable color during storage. This is due to the fact that food grade colors normally absorb onto the protein surface and fade as protein precipitates or settles out of solution over time. An emulsion system prevents color from fading by forming a stable homogenous suspension.

U.S. Pat. No. 5,286,511 (Klavons et al., Feb. 15, 1994) provides a beverage such as orange juice that is clouded by a suspension of soy protein particles, where the protein particles are prevented from aggregating to the point of settling out by pectin. Pectin inhibits the protein from settling by adsorbing to individual protein particles and imparting an overall negative charge to the protein particles, resulting in repulsion of the particles from one another, and thereby preventing the protein particles from aggregating and settling out of the suspension. Pectin also increases the viscosity of the beverage, which helps stabilize protein particles against gravitational forces.

U.S. Pat. No. 6,221,419 (Gerrish, Apr. 24, 2001) relates to a pectin for stabilizing proteins particularly for use in stabilizing proteins present in aqueous acidified milk drinks. It must be understood that the inclusion of pectin has both desirable and undesirable effects on the properties of acidified milk drinks. While pectin can act as a stabilizer against sedimentation of casein particles or whey separation, it can have the disadvantage of increasing the viscosity of the drink due to its cross-linking with naturally co-present calcium cations rendering the drink unpalatable. It will be seen that in the absence of pectin, there is significant sedimentation in the case of both drinks caused by the instability of the casein particles which also results in relatively high viscosity. After a certain concentration of pectin has been added, the casein particles become stabilized against sedimentation after which increasing the pectin concentration has little effect on sedimentation. Turning to the viscosity of the drinks, this also significantly drops on stabilisation of the casein particles but then almost immediately begins to rise again due to cross-linking of the excess pectin added by the co-present calcium cations. This increased viscosity is undesirable as it leads to the beverage having poor organoleptic properties. This range may be as narrow as only 0.06% by weight of pectin based upon the beverage weight as a whole. Below this working range, sedimentation is a significant problem, whereas above it, the viscosity of the beverage is undesirably high.

U.S. Pat. No. 6,413,561 (Sass et al., Jul. 2, 2002) relates to an acid beverage which contains at least one fat, one hydrocolloid, one milk protein and calcium and magnesium ions, at a pH of 3.5 to 4.5. The fat used in the beverage, according to the reference, may be derived from any desired vegetable, animal or synthetic fats or fat sources or mixtures thereof. The fat source used is preferably milk, usually cow's, having a fat content of 0.3 to 4%. The total fat content in the acid beverage is normally 0.003 to 3.8 g/l

### SUMMARY OF THE INVENTION

This invention is directed to an acid beverage composition, comprising;
(A) a hydrated protein stabilizing agent;
(B) a protein material;
(C) a triglyceride comprising a vegetable oil triglyceride, a genetically modified vegetable oil triglyceride or a synthetic triglyceride oil of the formula 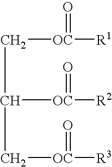
wherein R¹, R² and R³ are aliphatic groups and contain from about 7 up to about 23 carbon atoms; and

(D) a flavoring material comprising a fruit juice, a vegetable juice, glucono delta lactone, phosphoric acid or the sodium salts or acids of citric acid, malic acid, tartaric acid, lactic acid and, ascorbic acid; wherein the acid beverage composition has a pH of from 3.0 to 4.5.

Also disclosed is a process for preparing an acid beverage composition, comprising;
combining a first portion of
   (A) a protein stabilizing agent with
   (B) an aqueous mixture of a hydrated protein material and a basic salt to form blend (I);
adding to blend (I)
   (C) a triglyceride comprising a vegetable oil triglyceride, a genetically modified vegetable oil triglyceride or a synthetic triglyceride oil of the formula 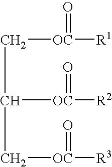
   wherein R¹, R² and R³ are aliphatic groups and contain from about 7 up to about 23 carbon atoms; followed by homogenization to form blend (II);
hydrating a second portion of a protein stabilizing agent and combining the hydrated protein stabilizing agent with
   (D) a flavoring material to form blend (III); and combining blend (II) and blend (III) to form a blend; and pasteurizing and homogenizing the blend; wherein the acid beverage composition has a pH of from 3.0 to 4.5.

### BRIEF DESCRIPTION OF THE DRAWINGS

FIG. 1 is a block flow diagram of an industry wide process for producing a typical protein containing acid beverage wherein a dry protein is hydrated as a protein slurry and a dry stabilizing agent is hydrated as a stabilizing agent slurry and the two slurries are blended together and the remaining ingredients added followed by pasteurization and homogenization.

FIG. 2 is a block flow diagram of the process of this invention for producing a protein containing acid beverage A first portion of a stabilizing agent is hydrated in the presence of a hydrated protein. Oil is then added and a second portion of a stabilizing agent is hydrated and any remaining ingredients are combined and added to the oil blend followed by pasteurization and homogenization in accordance with the principles of the invention.

### DETAILED DESCRIPTION OF THE INVENTION

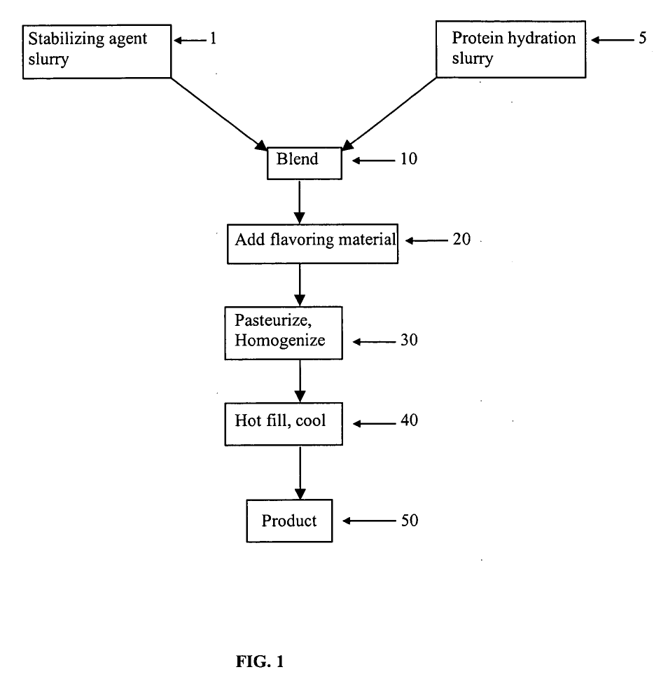

A protein based acid beverage is normally stabilized by a stabilizing agent that provides a stable suspension through possible steric stabilization and electrostatic repulsive mechanism. FIG. 1 refers to the normal processing conditions of protein stabilized acid beverages. At 1, a stabilizing agent is either hydrated separately into a 2-3% slurry or blended with sugar to give a stabilizing agent slurry having a pH of 3.5. At 5, dry protein powder is first dispersed in water at ambient temperature and hydrated at an elevated temperature for a period of time. The pH at 5 is about neutral. The hydrated stabilizing agent slurry from 1 and the hydrated protein slurry from 5 are mixed together at 10 for 10 minutes under agitation. The pH at 10 is about 7. Other ingredients such as additional sugar, fruit juices or vegetable juice, and various acids such as phosphoric acid, ascorbic acid citric acid, etc., are added at 20 to bring the pH to about 3.8. The contents are pasteurized at 195° F. for 30 seconds and then homogenized first at 2500 pounds per square inch and then at 500 pounds per square inch at 30. Containers are hot filled and cooled at 40 to give the product at 50 with a pH of 3.8. The problem with this method is that after the stabilizing agent is mixed with the protein, the pH of the blend is close to neutral, and the stabilizing agent is potentially degraded by beta-elimination, especially under heat. This causes a decrease in the molecular weight of the stabilizing agent and the ability of the stabilizing agent to stabilize the proteins when the pH is later lowered even more is greatly reduced. The stabilizing agent is only stable at room temperature. As the temperature increases, beta elimination begins, which results in chain cleavage and a very rapid loss of the ability of the stabilizing agent to provide a stable suspension.

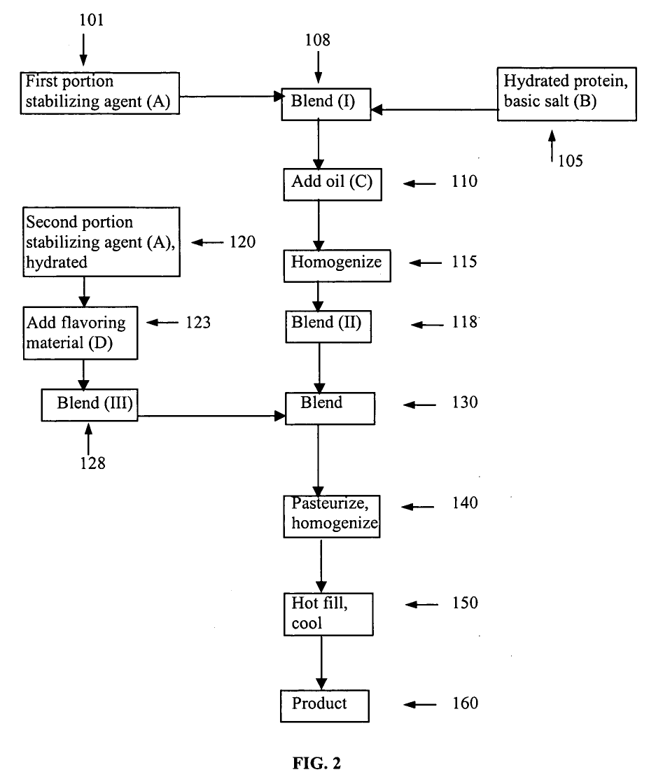

FIG. 2 outlines the process of this invention. At 105, a basic salt solution of sodium citrate is prepared and a protein material is added and permitted to hydrate to form (B). Two portions of a protein stabilizing agent (A) are utilized. A first portion at 101, with or without sugar is added to (B) to hydrate and to form blend (I) at 108. At 110, a vegetable oil (C) is added to blend (I) and the contents are homogenized at 115 to give blend (II) at 118. A second portion of a protein stabilizing agent (A) is hydrated at 120. The pH at 120 is 3.5. The second portion of the protein stabilizing agent, now hydrated at 120 is combined with a flavoring material (D) at 123 to form blend (III) at 128. Blend (II) from 118 and blend (III) from 128 are combined to give a blend at 130. The contents of this blend are pasteurized at 195° F. for 30 seconds and then homogenized first at 2500 pounds per square inch and then at 500 pounds per square inch at 140. Containers are hot filled and cooled at 150 to give the product at 160 with a pH of 3.8.

Component (A)

The present invention employs two portions of a protein stabilizing agent and the protein stabilizing agent is a hydrocolloid comprising alginate, microcrystalline cellulose, jellan gum, tara gum, carrageenan, guar gum, locust bean gum, xanthan gum, cellulose gum and pectin. A preferred hydrocolloid is pectin. As used herein, the term “pectin” means a neutral hydrocolloid that consists mainly of partly methoxylated polygalacturonic acid. The term “high methoxyl pectin” as used herein means a pectin having a degree of methoxyl esterification of fifty percent (50%) or greater. High methoxyl (HM) pectins useful in the present invention are commercially available. One supplier is Copenhagen Pectin A/S, a division of Hercules Incorporated, DK-4623, Lille Skensved, Denmark. Their products are identified as Hercules YM100L, Hercules YM100H, Hercules YM115L, Hercules YM115H and Hercules YM150H. Hercules YM100L contains about 56% galacturonic acid, where about 72% (±2%) of the galacturonic acid is methylated. Another supplier is Danisco A/S of Copenhagen, Denmark and they supply AMD783.

Prior to preparing the acid beverage, it is necessary to hydrate both the first portion and the second portion of the protein stabilizing agent. Either water is added to the protein stabilizing agent to form a slurry or the protein stabilizing agent is added to water to form a slurry to effect hydration of the protein stabilizing agent. The slurry is mixed at room temperature under high shear and heated to 140-180° F. for 10 minutes. At this solids concentration, the most complete hydration is obtained in the stabilizing agent. Thus, the water in the slurry is used most efficiently. A sweetener may be added at this point or later or a portion of the sweetener added here and also added later. Preferred sweeteners comprise sucrose, corn syrup, and may include dextrose and high fructose corn syrup and artificial sweeteners.

Component (B)

The protein material within (B) may be any vegetable or animal protein that is at least partially insoluble in an aqueous acidic liquid, preferably in an aqueous acidic liquid having a pH of from 3.0 to 5.5, and most preferably in an aqueous acidic liquid having a pH of from 3.5 to 4.5. As used herein a “partially insoluble” protein material is a protein material that contains at least 10% insoluble material, by weight of the protein material, at a specified pH. Preferred protein materials useful in the composition of the present invention include soy protein materials, casein or caseinates, corn protein materials—particularly zein, and wheat gluten. Preferred proteins also include dairy whey protein (especially sweet dairy whey protein), and non-dairy-whey proteins such as bovine serum albumin, egg white albumin, and vegetable whey proteins (i.e., non-dairy whey protein) such as soy protein.

Soybean protein materials which are useful with the present invention are soy flour, soy concentrate, and, most preferably, soy protein isolate. The soy flour, soy concentrate, and soy protein isolate are formed from a soybean starting material which may be soybeans or a soybean derivative. Preferably the soybean starting material is either soybean cake, soybean chips, soybean meal, soybean flakes, or a mixture of these materials. The soybean cake, chips, meal, or flakes may be formed from soybeans according to conventional procedures in the art, where soybean cake and soybean chips are formed by extraction of part of the oil in soybeans by pressure or solvents, soybean flakes are formed by cracking, heating, and flaking soybeans and reducing the oil content of the soybeans by solvent extraction, and soybean meal is formed by grinding soybean cake, chips, or flakes.

The soy flour, soy concentrate and soy protein isolate are described below as containing a protein range based upon a “moisture free basis” (mfb).

Soy flour, as that term is used herein, refers to a comminuted form of defatted soybean material, preferably containing less than 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a soy protein content of about 49% to about 65% on a moisture free basis (mfb). Preferably the flour is very finely ground, most preferably so that less than about 1% of the flour is retained on a 300 mesh (U.S. Standard) screen.

Soy concentrate, as the term is used herein, refers to a soy protein material containing about 65% to about 72% of soy protein (mfb). Soy concentrate is preferably formed from a commercially available defatted soy flake material from which the oil has been removed by solvent extraction. The soy concentrate is produced by an acid leaching process or by an alcohol leaching process. In the acid leaching process, the soy flake material is washed with an aqueous solvent having a pH at about the isoelectric point of soy protein, preferably at a pH of about 4.0 to about 5.0, and most preferably at a pH of about 4.4 to about 4.6. The isoelectric wash removes a large amount of water soluble carbohydrates and other water soluble components from the flakes, but removes little of the protein and fiber, thereby forming a soy concentrate. The soy concentrate is dried after the isoelectric wash. In the alcohol leaching process, the soy flake material is washed with an aqueous ethyl alcohol solution wherein ethyl alcohol is present at about 60% by weight. The protein and fiber remain insoluble while the carbohydrate soy sugars of sucrose, stachyose and raffinose are leached from the defatted flakes. The soy soluble sugars in the aqueous alcohol are separated from the insoluble protein and fiber. The insoluble protein and fiber in the aqueous alcohol phase are then dried.

Soy protein isolate, as the term is used herein, refers to a soy protein material containing at least about 90% or greater protein content, and preferably from about 92% or greater protein content (mfb). Soy protein isolate is typically produced from a starting material, such as defatted soybean material, in which the oil is extracted to leave soybean meal or flakes. More specifically, the soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. The defatted soy protein material or soybean flakes are then placed in an aqueous bath to provide a mixture having a pH of at least about 6.5 and preferably between about 7.0 and 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the protein. Typically, the pH of the aqueous extract of protein will be at least about 6.5 and preferably about 7.0 to 10.0. The ratio by weight of the aqueous extractant to the vegetable protein material is usually between about 20 to 1 and preferably a ratio of about 10 to 1. In an alternative embodiment, the vegetable protein is extracted from the milled, defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the extracts to, at or near the isoelectric point of the protein to form an insoluble curd precipitate. The actual pH to which the protein extracts are adjusted will vary depending upon the vegetable protein material employed but insofar as soy protein, this typically is between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the protein material is subjected to a pasteurization step. The pasteurization step kills microorganisms that may be present. Pasteurization is carried out at a temperature of at least 180° F. for at least 10 seconds, at a temperature of at least 190° F. for at least 30 seconds or at a temperature of at least 195° F. for at least 60 seconds. The protein material is then dried using conventional drying means to form a soy protein isolate. Soy protein isolates are commercially available from Solae® LLC, for example, as SUPRO® PLUS 675, FXP 950, FXP HO120, SURPO® XT 40, SUPRO® 710 and SUPRO® 720.

Preferably the protein material used in the present invention, is modified to enhance the characteristics of the protein material. The modifications are modifications which are known in the art to improve the utility or characteristics of a protein material and include, but are not limited to, denaturation and hydrolysis of the protein material.

The protein material may be denatured and hydrolyzed to lower the viscosity. Chemical denaturation and hydrolysis of protein materials is well known in the art and typically consists of treating an aqueous protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a protein material are: a pH of up to about 10, preferably up to about 9.7; a temperature of about 50° C. to about 80° C. and a time period of about 15 minutes to about 3 hours, where the denaturation and hydrolysis of the aqueous protein material occurs more rapidly at higher pH and temperature conditions.

Hydrolysis of the protein material may be effected by treating the protein material with an enzyme capable of hydrolyzing the protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of the protein material, typically from about 0.1% to about 10% enzyme by weight of the protein material, and treating the enzyme and protein material at a temperature, typically from about 5° C. to about 75° C., and a pH, typically from about 3 to about 9, at which the enzyme is active for a period of time sufficient to hydrolyze the protein material. After sufficient hydrolysis has occurred the enzyme is deactivated by heating to a temperature above 75° C., and the protein material is precipitated by adjusting the pH of the solution to about the isoelectric point of the protein material. Enzymes having utility for hydrolysis in the present invention include, but are not limited to, bromelain and alcalase.

Casein protein materials useful in the process of the present invention are prepared by coagulation of a curd from skim milk. The casein is coagulated by acid coagulation, natural souring, or rennet coagulation. To effect acid coagulation of casein, a suitable acid, preferably hydrochloric acid, is added to milk to lower the pH of the milk to around the isoelectric point of the casein, preferably to a pH of from 4.0 to 5.0, and most preferably to a pH of from 4.6 to 4.8. To effect coagulation by natural souring, milk is held in vats to ferment, causing lactic acid to form. The milk is fermented for a sufficient period of time to allow the formed lactic acid to coagulate a substantial portion of the casein in the milk. To effect coagulation of casein with rennet, sufficient rennet is added to the milk to precipitate a substantial portion of the casein in the milk. Acid coagulated, naturally soured, and rennet precipitated casein are all commercially available from numerous manufacturers or supply houses.

Corn protein materials that are useful in the present invention include corn gluten meal, and most preferably, zein. Corn gluten meal is obtained from conventional corn refining processes, and is commercially available. Corn gluten meal contains about 50% to about 60% corn protein and about 40% to about 50% starch. Zein is a commercially available purified corn protein which is produced by extracting corn gluten meal with a dilute alcohol, preferably dilute isopropyl alcohol.

Wheat protein materials that are useful in the process of the present invention include wheat gluten. Wheat gluten is obtained from conventional wheat refining processes, and is commercially available.

In addition to the presence of a protein material, (B) also contains a monovalent cation basic salt. The basic salt is selected from the group consisting of sodium citrate, sodium malate, sodium lactate and sodium formate. A preferred basic salt is sodium citrate. The purpose of the basic salt is to enhance the solubility of the protein material in the acid beverage. A slurry of a protein material will have a pH of below 7.0. The basic salt is added in sufficient quantity to cause the slurry (B) to have a pH of between 7.0 to 8.0 and preferably from 7.3 to 7.7.

It is necessary to hydrate the protein material within (B), prior to preparing the acid beverage. The dry protein material is added to the aqueous basic salt solution such that a slurry is formed. It is critical to hydrate the protein material. The slurry (B) contains from 1-10% by weight solids based on the weight of the slurry. More preferably, the slurry (B) contains from 1-7% by weight solids. Most preferably the slurry (B) contains from 1-6% by weight solids. The slurry is mixed at room temperature under high shear and heated to 140-180° F. for an additional 10 minutes to hydrate the protein. At this solids concentration, the most complete hydration is obtained in the protein. Thus, the water in the slurry is used most efficiently at this concentration.

(C) The Triglyceride Oil

In practicing this invention, a triglyceride oil is employed. The purpose of this oil is to provide a comfortable body to the acid beverage, as well as a lifting force to help prevent protein material precipitation. The oil provides an oil-in-water stable emulsion. The term “oil-in-water emulsion” refers to emulsions wherein a discontinuous phase is dispersed within a continuous phase. The oil is the discontinuous phase and water is the continuous phase. The stabilizing agent (A) functions as an emulsifier for the oil-in-water emulsion containing the protein material (A). Acid beverages formulated with an oil-in-water emulsion also provide a stable color during storage. A food grade color typically absorbs onto the surface of the protein. Any protein that settles to the bottom will cause a color change in the acid beverage. The oil-in-water emulsion prevents color from fading by forming a stable homogeneous protein suspension.

The triglyceride oil employed comprises a vegetable oil triglyceride, a genetically modified vegetable oil triglyceride or a synthetic triglyceride oil of the formula 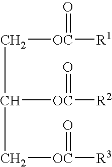
wherein R¹, R² and R³ are aliphatic groups that contain from about 7 up to about 23 carbon atoms;

The aliphatic groups are alkyl groups such as heptyl, nonyl, decyl, undecyl, tridecyl, heptadecyl, and octyl; alkenyl groups containing a single double bond such as heptenyl, nonenyl, undecenyl, tridecenyl, heptadecenyl, heneicosenyl; alkenyl groups containing 2 or 3 double bonds such as 8,11-heptadecadienyl and 8,11,14-heptadecatrienyl, and alkynyl groups containing triple bonds. All isomers of these are included, but straight chain groups are preferred.

All triglyceride oils contain varying amounts of saturated, monounsaturated or polyunsaturated character. Genetically modified vegetable oil triglycerides can be prepared with a high (greater than 60 or 70 or even 80%) monounsaturated character at the expense of having a low saturated and low polyunsaturated character. Synthetic triglyceride oils can be prepared with any amount of saturated, monounsaturated or polyunsaturated character. That is, a synthetic triglyceride oil may be synthesized to contain 100% saturated, or 100% monounsaturated or 100% polyunsaturated character. A synthetic triglyceride oil can be synthesized to have whatever character is desired.

Regular vegetable oil triglycerides (non-genetically modified) have a wide variety of saturated, monounsaturated or polyunsaturated character as shown in the below table.

| | Character | | |
|---|---|---|---|
| Oil | Saturated | Monounsaturated | Polyunsaturated |
| Peanut | 22% | 49% | 29% |
| Rapeseed | 7 | 63 | 30 |
| Soybean | 15 | 23 | 62 |
| Olive | 15 | 75 | 10 |
| Sunflower | 13 | 22 | 65 |
| Palm kernel | 83 | 15 | 2 |
| Corn | 15 | 26 | 59 |
| Coconut | 92 | 5 | 3 |
| Palm | 50 | 40 | 10 |

The preferred vegetable oil triglycerides have a saturated character of less than 30% to ensure that the oil is in liquid form at room temperature. The preferred vegetable oil triglycerides are peanut oil, canola oil, rapeseed oil, soybean oil, olive oil, sunflower oil and corn oil. Canola oil is a variety of rapeseed oil containing less than 1% erucic acid. The most preferred vegetable oil triglyceride is sunflower oil.

The synthetic triglycerides are those formed by the reaction of one mole of glycerol with three moles of a fatty acid or mixture of fatty acids.

Genetically modified vegetable oil triglycerides are prepared from oil seeds that have been genetically modified to produce a higher than normal monounsaturated character. For a genetically modified vegetable oil triglyceride, the fatty acid moieties are such that the triglyceride oil has a monounsaturated character of at least 60 percent, preferably at least 70 percent and most preferably at least 80 percent. These genetically modified vegetable oil triglycerides are produced by plants that contain a higher than normal oleic acid content. Normal sunflower oil has an oleic acid content of 18-40 percent. By genetically modifying the sunflower seeds, a sunflower oil can be obtained wherein the oleic content is from about 60 percent up to about 92 percent. That is, the R¹, R² and R³ groups are heptadecenyl groups and the R¹COO—, R²COO—, and R³COO— that are attached to the 1,2,3-propanetriyl group—CH₂CHCH₂—are the residue of an oleic acid molecule. U.S. Pat. Nos. 4,627,192 and 4,743,402 are herein incorporated by reference for their disclosure to the preparation of high oleic sunflower oil.

A triglyceride oil, regardless of its source, comprised exclusively of an oleic acid moiety has an oleic acid content of 100% and consequently a monounsaturated character of 100%. Where the triglyceride is made up of acid moieties that are 70% oleic acid, 10% stearic acid, 13% palmitic acid, and 7% linoleic, the saturated character is 23%, the monounsaturated character is 70% and the polyunsaturated character is 7%. The preferred genetically modified vegetable oil triglycerides are high oleic acid (at least 60 percent) vegetable oil triglycerides. Typical genetically modified high oleic vegetable oil triglycerides employed within the instant invention are high oleic peanut oil, high oleic corn oil, high oleic sunflower oil, and high oleic soybean oil. A preferred genetically modified high oleic vegetable oil is genetically modified high oleic sunflower oil obtained from Helianthus sp. This product is available from A. C. Humko Corporation, Memphis, Tenn. as Sunyl® high oleic sunflower oil. Sunyl 100 oil is a genetically modified high oleic vegetable oil triglyceride wherein the acid moieties comprise at least 85 percent oleic acid.

It is to be noted the olive oil and rapeseed oil are excluded as a genetically modified vegetable oil triglyceride (C) in this invention. The oleic acid content of olive oil typically ranges from 65-85 percent and rapeseed oil is about 63 percent. These monounsaturated contents, however, are not achieved through genetic modification, but rather are naturally occurring.

It is further to be noted that genetically modified vegetable oil triglycerides have high oleic acid contents at the expense of the di- and tri-unsaturated acids. A normal sunflower oil has from 20-40 percent oleic acid moieties and from 50-70 percent linoleic acid moieties. This gives a 90 percent character of mono- and di-unsaturated acid moieties (20+70) or (40+50). Genetically modifying vegetable oil triglycerides generate a low di- or tri-unsaturated moiety vegetable oil triglyceride. The genetically modified vegetable oil triglycerides of this invention have an oleic acid moiety:linoleic acid moiety ratio of from about 2 up to about 90. A 60 percent oleic acid moiety character and 30 percent linoleic acid moiety character of a triglyceride oil gives a ratio of 2. A triglyceride oil made up of an 80 percent oleic acid moiety and 10 percent linoleic acid moiety gives a ratio of 8. A triglyceride oil made up of a 90 percent oleic acid moiety and 1 percent linoleic acid moiety gives a ratio of 90. The ratio for normal sunflower oil is about 0.5 (30 percent oleic acid moiety and 60 percent linoleic acid moiety).

The preferred triglyceride oils are vegetable oil triglycerides and genetically modified vegetable oil triglycerides.

Component (D)

A protein material by itself can have an undesired aftertaste or undesired flavors. The function of the flavoring material (D) is to mask any adverse flavors of the protein material (B) and to give a pleasant taste to the acid beverage composition. The flavoring material (D) comprises a fruit juice, a vegetable juice, citric acid, malic acid, tartaric acid, lactic acid, ascorbic acid, glucone delta lactone, phosphoric acid or combinations thereof.

As a juice, the fruit and/or vegetable may be added in whole, as a liquid, a liquid concentrate, a puree or in another modified form. The liquid from the fruit and/or vegetable may be filtered prior to being used in the juice product. The fruit juice can include juice from tomatoes, berries, citrus fruit, melons and/or tropical fruits. A single fruit juice or fruit juice blends may be used. The vegetable juice can include a number of different vegetable juices. Examples of a few of the many specific juices which may be utilized in the present invention include juice from berries of all types, currants, apricots, peaches, nectarines, plums, cherries, apples, pears, oranges, grapefruits, lemons, limes, tangerines, mandarin, tangelo, bananas, pineapples, grapes, tomatoes, rhubarbs, prunes, figs, pomegranates, passion fruit, guava, kiwi, kumquat, mango, avocados, all types of melon, papaya, turnips, rutabagas, carrots, cabbage, cucumbers, squash, celery, radishes, bean sprouts, alfalfa sprouts, bamboo shoots, beans and/or seaweed. As can be appreciated, one or more fruits, one or more vegetables, and/or one or more fruits and vegetables, can be included in the acid beverage to obtain the desired flavor of the acid beverage.

Fruit and vegetable flavors can also function as the flavoring material (D). Fruit flavoring has been found to neutralize the aftertaste of protein materials. The fruit flavoring may be a natural and/or artificial flavoring. As can be appreciated, the fruit flavoring is best when used with other flavoring materials such as vegetable flavoring to enhance the characterizing flavor of the acid beverage and also to mask any undesirable flavor notes that may derive from the protein material.

Once components (A), (B) (C) and (D) are prepared, all that remains is to combine the components to form the acid beverage composition according to the process of the invention. Two separate slurries of the protein stabilizing agent (A) are hydrated. Sugar may be added to one, both or neither slurry. Component (B) is prepared by dissolving the basic salt in water followed by the addition of dry protein in order to hydrate the protein. The first portion of the hydrated protein stabilizing agent (A) is combined with (B) to form blend (I). It is necessary to combine a portion of the protein stabilizing agent (A) in an aqueous medium with the protein from (B) in an aqueous medium. This permits that portion of the protein stabilizing agent (A) to interact with the protein rather than agglomerating the protein, which would occur if all the protein stabilizing agent were added to (B).

The triglyceride oil (C) is added to blend (I) to form an oil-in-water emulsion. After formation of the emulsion, the contents are homogenized to form blend (II). Homogenization serves to decrease the particle size of the protein in blend (II). Homogenization is conducted in a Gaulin homogenizer (model 15MR) in two stages, a high pressure stage and a low pressure stage. The high pressure stage is from 1500-5000 pounds per square inch and preferably from 2000-3000 pounds per square inch. The low pressure stage is from 300-1000 pounds per square inch and preferably from 400-700 pounds per square inch.

The second portion of the hydrated protein stabilizing agent (A) is combined with (D) to form blend (III).

Blend (II) and blend (III) are combined to form the blend of the acid beverage composition. The blend is subjected to a sterilization or pasteurization step and to homogenization. Pasteurization in carried out by heating at a relatively high temperature for a short period of time. This pasteurization step kills microorganisms in the blend. For example, an effective treatment for killing microorganisms in the blend involves heating the blend to a temperature of about 180° F. for about 10 seconds, preferably to a temperature of at least 190° F. for at least 30 seconds and most preferably at a temperature of 195° F. for 60 seconds. While a temperature lower than 180° F. may work, a temperature of at least 180° F. provides a safety factor. Temperatures greater than 200° F. also have an effect on the killing of microorganisms. However, the cost associated with the higher temperature does not translate to a product that contains appreciably fewer harmful microorganisms. Further, pasteurizing at too high a temperature for too long a period of time may cause the protein to further denature, which generates more sediment due to the insolubility of the further denatured protein.

Homogenization is carried out in the identical manner as the homogenization to obtain blend (II), above.

The blend, after pasteurization and homogenization, has a pH of from 3.0-4.5, preferably from 3.2-4.0 and most preferably from 3.6-3.8. Bottles are hot filled, inverted for 2 minutes and then placed in ice water to bring the temperature of the contents to about room temperature. The contents of the bottles are the acid beverage composition.

In preparing blend (I), the first portion of dry (A): 100 parts (B) is generally from 0.1-0.4:100, preferably from 0.15-0.35:100 and most preferably from 0.2-0.3:100. In preparing blend (II), the (C):blend (I) weight ratio is generally from 3-15:85-97, preferably from 5-12:88-95 and most preferably from 70-80:20-30. In preparing blend (III), the second portion of hydrated (A):(D) weight ratio is generally from 50-90:10-50, preferably from 60-85:15-40 and most preferably from 70-80:20-30. In preparing the blend, the blend (III):blend (II) weight ratio is generally from 35-50:50-65, preferably from 38-48:52-62 and most preferably from 40-45:55-60.

Acid Beverages Compositions

Examples A is a baseline process example as defined within FIG. 1. The acid beverage composition of this example employs a dry protein as a protein source.

### Example A

A 6.5 g protein per 8 oz serving fortified juice beverage is made using FXP HO 220 protein made by Solae® LLC.

Added to a vessel are 5494 g of distilled water followed by 332 g of FXP HO 220 protein. The contents at 5.70% solids are dispersed under medium shear, mixed for 5 minutes, followed by heating to 170° F. for 10 minutes to give a protein suspension slurry. In a separate vessel, 60 grams of pectin (YM-100L) are dispersed into 2940 grams of distilled water under high shear to give a 2% pectin dispersion. The dispersion is heated to 170° F. until no lumps are observed. The pectin dispersion is added into the protein suspension slurry and mixed for 5 minutes under medium shear. This is followed by the addition of 27 grams of citric acid, 27 grams of phosphoric acid, 210 grams of concentrated apple juice and 1000 grams of sugar. The contents are mixed for 5 minutes under medium shear. The pH of this mixture at room temperature is in the range of 3.8-4.0. The contents are pasteurized at 195° F. for 30 seconds, and homogenized at 2500 pounds per square inch in the first stage and 500 pounds per square inch in the second stage to give a protein stabilized acid beverage. Bottles are hot filled with the beverage at 180-185° F. The bottles are inverted, held for 2 minutes and then placed in ice water to bring the temperature of the contents to about room temperature. After the contents of the bottles are brought to about room temperature, the bottles are stored at room temperature for 6 months.

The invention having been generally described above, may be better understood by reference to the examples described below. The following example represents a specific but non-limiting embodiment of the present invention.

### Example 1

A 6.5 g protein per 8 oz serving fortified juice beverage is made using FXP HO 220 protein made by Solae® LLC.

Added to a vessel is 150 g sodium citrate in 5000 g deionized water. After the sodium citrate has dissolved, 153 g FXP HO220, available from Solae, LLC is added. The contents are heated to 180° F. and held for 8 minutes to hydrate the protein material. In a separate vessel, a first portion of a stabilizing agent is prepared by dry mixing 150 g pectin and 300 g sucrose, which is then added to the hydrated protein vessel to hydrate the pectin and to form blend (I). High oleic sunflower oil, 500 g as Trisun 100 having a monounsaturated content of at least 85% is added to blend (I) to form an oil-in-water emulsion and permitted to mix at 180° F. for 5 minutes and then homogenized in two stages, a high pressure stage of 2500 pounds per square inch and a low pressure stage of 500 pounds per square inch to form blend (II). In another vessel, a second portion of a stabilizing agent is prepared by adding 250 g pectin and 3400 g water to hydrate the pectin. A flavoring material as a solution of 400 g sucrose, 164 g apple juice concentrate and 350 citric acid is added to the second portion of a stabilizing agent, now hydrated, to form blend (III). Blend (II) and blend (III) are combined to form a blend and the blend is pasteurized at 195° F. for 60 seconds, followed by homogenization in two stages, a high pressure stage of 2500 pounds per square inch and a low pressure stage of 500 pounds per square inch. The pH is 3.86. Bottles are hot filled, inverted for 2 minutes and then placed in ice water to bring the temperature of the contents to about room temperature. The bottles are stored and viscosity, serum and sediment values are determined at 1 month at 4° C. in a side-by-side comparison.

The serum and sediment values are determined by filling 250 milliliter narrow mouth square bottles (Nalge Nunc International) with each beverage. The percentage of sediment and percentage of serum of each sample is then measured to determine the effectiveness of stabilization in each beverage (Sediment=solid material that has fallen out of solution/suspension; Serum=clear layer of solution containing little or no suspended protein). The percentage of sediment is determined by measuring the height of the sediment layer in the sample and measuring the height of the entire sample, where Percent Sediment=(Ht. Sediment layer)/(Ht. Total Sample)×100. The percentage of serum is determined by measuring the height of the serum layer in the sample and measuring the height of the entire sample, where Percent Serum=(Ht. Serum Layer)/(Ht. Total Sample)×100. Visual observations are also made with respect to the homogenity, or lack thereof, of the samples. The results of the tests are shown in Table 1 below.

The baseline process beverage Example A and the inventive process beverage Example 1 are compared to each other, protein for protein, in Table I.

TABLE I
One Month Acid Beverage Evaluations

| | Example A | Example 5 |
|---|---|---|
| pH | 4.02 | 3.86 |
| Viscosity at 25° C¹ | 6.0 Cps | 6.58 Cps |
| % Serum | 0 | 0 |
| % Sediment | 3.3 | 0 |
| Observation | not stable | stable |

¹Brookfield Model DV-II viscometer equipped with spindle S18. The examples are run at 60 rpm. The reported values are in centipoise (Cps).

It is observed from the storage sediment data of the above examples that the embodiments encompassing the process of this invention offer an improvement in less sediment in preparing a protein based acid beverage over the normal process for preparing the beverage.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

1. An acid beverage composition, comprising;
(A) a hydrated protein stabilizing agent;
(B) a protein material;
(C) a triglyceride comprising a vegetable oil triglyceride, a genetically modified vegetable oil triglyceride or a synthetic triglyceride oil of the formula 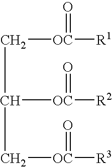
wherein R¹, R² and R³ are aliphatic groups and contain from about 7 up to about 23 carbon atoms; and
(D) a flavoring material comprising a fruit juice, a vegetable juice, glucono delta lactone, phosphoric acid or the sodium salts or acids of citric acid, malic acid, tartaric acid, lactic acid and, ascorbic acid;
wherein the acid beverage composition has a pH of from 3.0 to 4.5.

2. The composition of claim 1 wherein the protein stabilizing agent (A) 2 comprises a hydrocolloid.

3. The composition of claim 2 wherein the hydrocolloid comprises alginate, microcrystalline cellulose, jellan gum, tara gum, carrageenan, guar gum, locust bean gum, xanthan gum, cellulose gum and pectin.

4. The composition of claim 1 wherein the protein stabilizing agent (A) is a high methoxyl pectin.

5. The composition of claim 1 wherein the pH of the protein stabilizing agent (A) is from 2.0-5.5.

6. The composition of claim 1 wherein the protein material (B) comprises a soybean protein material, casein, whey protein, wheat gluten or zein.

7. The composition of claim 6 wherein the soybean protein material comprises a soy flour, soy concentrate or soy protein isolate.

8. The composition of claim 3 wherein the soybean protein material comprises a soy protein isolate.

9. The composition of claim 1 wherein the protein material (B) comprises a hydrolyzed protein material or a non-hydrolyzed protein material.

10. The composition of claim 9 wherein the protein material (B) comprises a hydrolyzed protein material.

11. The composition of claim 1 wherein within (B) the slurry has a solids content of from 1-10% by weight.

12. The composition of claim 1 wherein within (B) the slurry has a solids content of from 1-7% by weight.

13. The composition of claim 1 wherein within (B) the slurry has a solids content of from 1-6% by weight.

14. The composition of claim 1 wherein the triglyceride comprises a vegetable oil triglyceride or a genetically modified vegetable oil triglyceride.

15. The composition of claim 1 wherein the synthetic triglyceride oil is an ester of at least one straight chain fatty acid and glycerol.

16. The composition of claim 15 wherein the fatty acid is oleic acid.

17. The composition of claim 14 wherein the vegetable oil triglyceride comprises peanut oil, soybean oil, corn oil, olive oil, sunflower oil and rapeseed oil.

18. The composition of claim 14 wherein within the genetically modified vegetable oil, R¹, R² and R³ have at least a 60 percent monounsaturated character.

19. The composition of claim 18 wherein the monounsaturated character is an oleic acid fatty acid residue.

20. The composition of claim 18 wherein the genetically modified vegetable oil comprises a genetically modified peanut oil, a genetically modified soybean oil, a genetically modified corn oil or a genetically modified sunflower oil.

21. The composition of claim 18 wherein the genetically modified vegetable oil has an oleic acid moiety:linoleic acid moiety of from about 2 up to about 90.

22. The composition of claim 1 wherein the pH of the acid beverage composition is from 3.2-4.0.

23. The composition of claim 1 wherein the pH of the acid beverage composition is from 3.6-3.8.

24. A process for preparing a stable suspension of a protein material in an acid beverage, comprising;
combining a first portion of
(A) a protein stabilizing agent with
(B) an aqueous mixture of a hydrated protein material and a basic salt to form blend (I);
adding to blend (I)
(C) a triglyceride comprising a vegetable oil triglyceride, a genetically modified vegetable oil triglyceride or a synthetic triglyceride oil of the formula 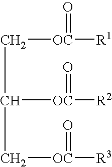
wherein R¹, R² and R³ are aliphatic groups and contain from about 7 up to about 23 carbon atoms; followed by homogenization to form blend (II);
hydrating a second portion of a protein stabilizing agent and combining with
(D) a flavoring material to form blend (III); and
combining blend (II) and blend (III) to form a blend; and
pasteurizing and homogenizing the blend;
wherein the acid beverage composition has a pH of from 3.0 to 4.5.

25. The process of claim 24 wherein the protein stabilizing agent (A) comprises a hydrocolloid.

26. The process of claim 25 wherein the hydrocolloid comprises alginate, microcrystalline cellulose, jellan gum, tara gum, carrageenan, guar gum, locust bean gum, xanthan gum, cellulose gum and pectin.

27. The process of claim 24 wherein the protein stabilizing agent (A) is a high methoxyl pectin.

28. The process of claim 24 wherein the pH of the protein stabilizing agent (A) is from 2.0-5.5.

29. The process of claim 24 wherein the protein material (B) comprises a soybean protein material, casein, whey protein, wheat gluten or zein.

30. The process of claim 29 wherein the soybean protein material comprises a soy flour, soy concentrate or soy protein isolate.

31. The process of claim 29 wherein the soybean protein material comprises a soy protein isolate.

32. The process of claim 24 wherein the protein material (B) comprises a hydrolyzed protein material or a non-hydrolyzed protein material.

33. The process of claim 32 wherein the protein material (B) comprises a hydrolyzed protein material.

34. The process of claim 24 wherein within (B) the slurry has a solids content of from 1-10% by weight.

35. The process of claim 24 wherein within (B) the slurry has a solids content of from 1-7% by weight.

36. The process of claim 24 wherein within (B) the slurry has a solids content of from 1-6% by weight.

37. The process of claim 24 wherein the triglyceride comprises a vegetable oil triglyceride or a genetically modified vegetable oil triglyceride.

38. The process of claim 24 wherein the synthetic triglyceride oil is an ester of at least one straight chain fatty acid and glycerol.

39. The process of claim 38 wherein the fatty acid is oleic acid.

40. The process of claim 37 wherein the vegetable oil triglyceride comprises peanut oil, soybean oil, corn oil, olive oil, sunflower oil and rapeseed oil.

41. The process of claim 37 wherein within the genetically modified vegetable oil, R¹, R² and R³ have at least a 60 percent monounsaturated character.

42. The process of claim 41 wherein the monounsaturated character is an oleic acid fatty acid residue.

43. The process of claim 41 wherein the genetically modified vegetable oil comprises a genetically modified peanut oil, a genetically modified soybean oil, a genetically modified corn oil or a genetically modified sunflower oil.

44. The process of claim 24 wherein the genetically modified vegetable oil has an oleic acid moiety:linoleic acid moiety of from about 2 up to about 90.

45. The process of claim 24 wherein the pH of the acid beverage process is from 3.2-4.0.

46. The process of claim 24 wherein the pH of the acid beverage process is from 3.6-3.8.

47. The process of claim 24 wherein the basic salt is present in an amount sufficient so that (B) has a pH of from 7.0 to 8.0.

48. The process of claim 24 wherein the basic salt is present in an amount sufficient so that (B) has a pH of from 7.3 to 7.7.

49. The process of claim 24 wherein the basic salt is selected from the group consisting of sodium citrate, sodium malate, sodium lactate and sodium formate.

50. The process of claim 24 wherein the basic salt is sodium citrate.

51. The process of claim 24 wherein within blend (I), the first portion of (A):100 (B) is from 0.1-0.4:100.

52. The process of claim 24 wherein within blend (II), the weight ratio of (C):blend (I) is from 3-15:85-97.

53. The process of claim 24 wherein within blend (III), the weight ratio of the second portion of hydrated (A):(D) is from 50-90:10-50.

54. The process of claim 24 wherein within the blend, the weight ratio of blend (III):blend (II) is from 35-50:50-65.
